(19) United States
(12) Patent Application Publication
(10) Pub. No.: US 2026/0128224 A1
(43) Pub. Date: May 7, 2026

(54) THREE-TERMINAL MULTILAYER CERAMIC CAPACITOR

(71) Applicant: Murata Manufacturing Co., Ltd., Nagaokakyo-shi (JP)

(72) Inventors: Kentarou FUJIWARA, Nagaokakyo-shi (JP); Takashi SAWADA, Nagaokakyo-shi (JP)

(21) Appl. No.: 19/439,812

(22) Filed: Jan. 5, 2026

Related U.S. Application Data
(63) Continuation of application No. PCT/JP2024/016301, filed on Apr. 25, 2024.

(30) Foreign Application Priority Data
Jul. 10, 2023 (JP) 2023-112814

(51) Int. Cl. H01G 4/232; H01G 4/008; H01G 4/012; H01G 4/12; H01G 4/30

(52) U.S. Cl. CPC H01G 4/2325; H01G 4/008; H01G 4/012; H01G 4/1227; H01G 4/30

(57) ABSTRACT

A three-terminal multilayer ceramic capacitor includes a first internal electrode layer including a first facing electrode portion, and first and second extracting electrode portions extending from the first facing electrode portion to a first end surface and a second end surface, respectively, and a second internal electrode layer including a second facing electrode portion facing the first facing electrode portion, and third and fourth extracting electrode portions extending from the second facing electrode portion to first and second side surfaces, respectively, wherein thicknesses of the third and fourth extracting electrode portions in the height direction x>thicknesses of the first and second extracting electrode portions in the height direction x>at least one among thicknesses of the first and second facing electrode portions in the height direction.

### CROSS REFERENCE TO RELATED APPLICATIONS

This application claims the benefit of priority to Japanese Patent Application No. 2023-112814 filed on Jul. 10, 2023 and is a Continuation Application of PCT Application No. PCT/JP2024/016301 filed on Apr. 25, 2024. The entire contents of each application are hereby incorporated herein by reference.

### BACKGROUND OF THE INVENTION

### 1. Field of the Invention

The present invention relates to three-terminal multilayer ceramic capacitors.

### 2. Description of the Related Art

Japanese Unexamined Patent Application Publication No. 2022-39808 discloses a multilayer feedthrough ceramic capacitor having a general configuration, that is, a three-terminal multilayer ceramic capacitor. The three-terminal multilayer ceramic capacitor includes a multilayer body and external electrodes provided on an outer surface of the multilayer body. The multilayer body includes an inner layer portion and outer layer portions sandwiching the inner layer portion in the lamination direction. In the inner layer portion, a plurality of internal electrode layers are alternately provided with a corresponding one of plurality of ceramic layers interposed therebetween, and are connected to external electrodes. Further, the multilayer body includes an outer surface including first and second main surfaces opposed to each other, first and second lateral surfaces opposed to each other, and first and second end surfaces opposed to each other. The internal electrode layers include a plurality of first internal electrode layers and a plurality of second internal electrode layers. The plurality of first internal electrode layers and the plurality of second internal electrode layers are alternately laminated in a predetermined lamination direction with a corresponding one of the plurality of ceramic layers interposed therebetween. The first internal electrode layers are exposed at the first and second end surfaces, and the second internal electrode layers are exposed at the first and second lateral surfaces. The first internal electrode layers are connected to the first and second external electrodes at the first and second end surfaces, respectively. The second internal electrode layers are connected to the third and fourth external electrodes on the first and second lateral surfaces, respectively. In Japanese Unexamined Patent Application Publication No. 2022-39808, in the second internal electrode layers, the thickness of each of the extension regions exposed at the first and second lateral surfaces is greater than the thickness of the middle portion sandwiched between the extension regions. This improves the connectivity between the second internal electrode layers and the third and fourth external electrodes.

However, it is desired to further improve the moisture resistance reliability of the three-terminal multilayer ceramic capacitor.

### SUMMARY OF THE INVENTION

Example embodiments of the present invention provide three-terminal multilayer ceramic capacitors each with improved moisture resistance reliability.

A three-terminal multilayer ceramic capacitor according to an example embodiment of the present invention includes a multilayer body including a plurality of ceramic layers that are laminated, a first main surface and a second main surface opposed to each other in a height direction, a first end surface and a second end surface opposed to each other in a length direction orthogonal or substantially orthogonal to the height direction, and a first lateral surface and a second lateral surface opposed to each other in a width direction orthogonal or substantially orthogonal to the height direction and the length direction, a plurality of first internal electrode layers each on a corresponding one of the plurality of ceramic layers and each extending toward the first end surface and the second end surface, a plurality of second internal electrode layers each on a corresponding one of the plurality of ceramic layers and each extending toward the first lateral surface and the second lateral surface, a first external electrode on the first end surface and connected to the plurality of first internal electrode layers, a second external electrode on the second end surface and connected to the plurality of first internal electrode layers, a third external electrode on the first lateral surface and connected to the plurality of second internal electrode layers, a fourth external electrode on the second lateral surface and connected to the plurality of second internal electrode layers, in which each of the plurality of first internal electrode layers includes a first counter electrode portion opposed to the plurality of second internal electrode layers, a first extension electrode portion extending from the first counter electrode portion toward the first end surface, and a second extension electrode portion extending from the first counter electrode portion toward the second end surface, each of the plurality of second internal electrode layers includes a second counter electrode portion opposed to the plurality of first counter electrode portion, a third extension electrode portion extending from the second counter electrode portion toward the first lateral surface, and a fourth extension electrode portion extending from the second counter electrode portion toward the second lateral surface, and a relationship is satisfied in which thicknesses of the third extension electrode portion and the fourth extension electrode portion in the height direction>thicknesses of the first extension electrode portion and the second extension electrode portion in the height direction≥at least one of a thickness of the first counter electrode portion or a thickness of the second counter electrode portion in the height direction.

According to the above configuration, the moisture resistance reliability of the three-terminal multilayer ceramic capacitor is improved. The inventors of example embodiments of the present invention have discovered that, for the relationship among the thicknesses of the first and second extension electrode portions, the thicknesses of the third and fourth extension electrode portions, and the thicknesses of the first and second counter electrode portions, the relationship that causes an adverse effect such as a decrease in moisture resistance reliability, an increase in dimensions of the three-terminal multilayer ceramic capacitor, and configuration defects is the relationship of the thickness of the third and fourth extension electrode portions<the thickness of the first and second extension electrode portions≤the thickness of the first or second counter electrode portion. Based on this new discovery, it has been discovered that the thickness relationship is set such that the thickness of the third and fourth extension electrode portions>the thickness of the first and second extension electrode portions≥at least one of the thickness of the first or second counter electrode portion. As described above, the inventors of example embodiments of the present invention have discovered that it is possible to reduce or prevent a decrease in moisture resistance reliability, an increase in dimensions of a three-terminal multilayer ceramic capacitor, configuration defects, and the like by forming the internal electrode layers after defining the size relationships in consideration of all of the thicknesses of the third and fourth extension electrode portions, the thicknesses of the first and second extension electrode portions, and at least one of the thickness of the first or second counter electrode portion.

According to example embodiments of the present invention, three-terminal multilayer ceramic capacitors each with improved moisture resistance reliability are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view showing an example of a three-terminal multilayer ceramic capacitor according to an example embodiment of the present invention.

FIG. 2 is a top view showing an example of a three-terminal multilayer ceramic capacitor according to an example embodiment of the present invention.

FIG. 3 is a front view showing an example of a three-terminal multilayer ceramic capacitor according to an example embodiment of the present invention.

FIG. 4 is a cross-sectional view taken along the line IV-IV in FIG. 1.

FIG. 5 is a cross-sectional view taken along the line V-V in FIG. 1.

FIG. 6 is a cross-sectional view taken along the line VI-VI in FIG. 4.

FIG. 7 is a cross-sectional view taken along the line VII-VII in FIG. 4.

FIG. 8 is a schematic enlarged view of a portion of FIG. 4.

FIG. 9 is a schematic enlarged view of a portion of FIG. 5.

FIG. 10 is a schematic enlarged view of another example embodiment of the present invention of FIG. 4.

FIG. 11 is a schematic enlarged view showing a diffusion state of Ni.

### DETAILED DESCRIPTION OF THE EXAMPLE EMBODIMENTS

Example embodiments of the present invention will be described in detail below with reference to the drawings.

A three-terminal multilayer ceramic capacitor according to an example embodiment of the present invention will be described.

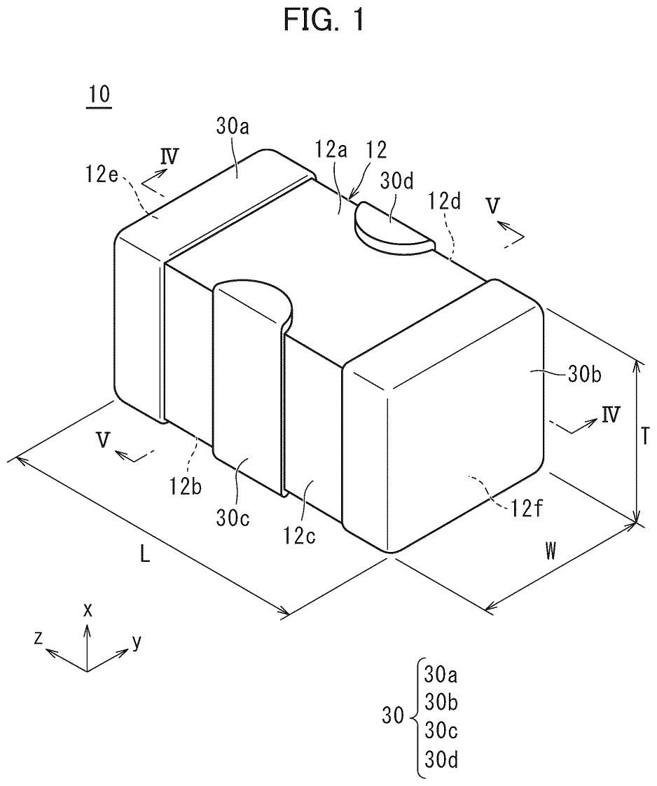

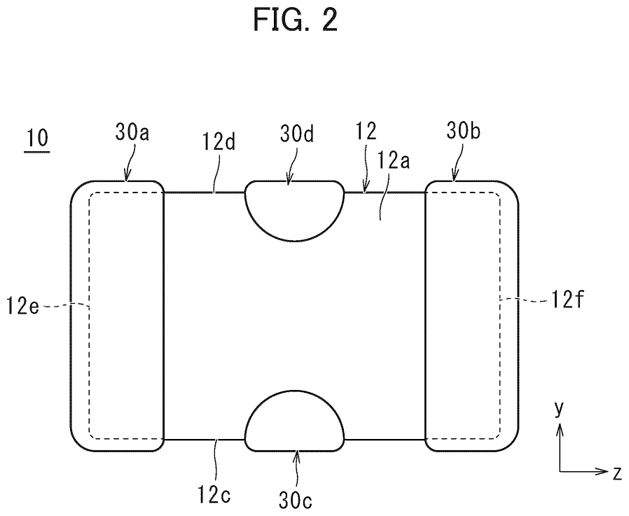

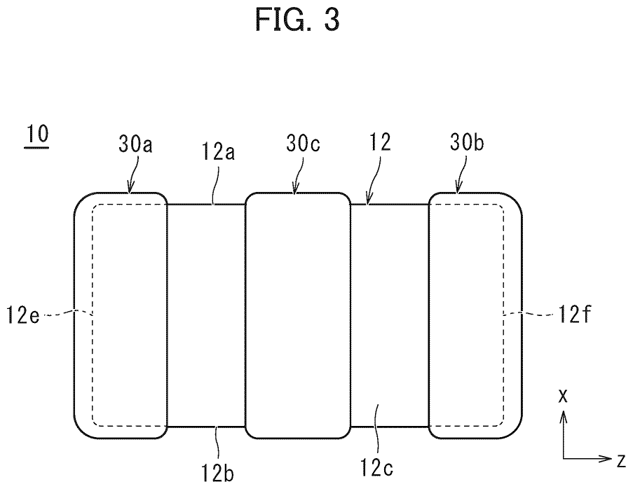

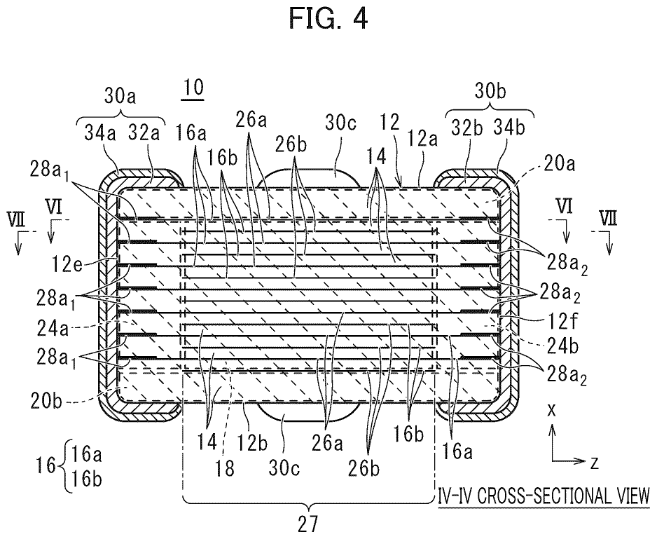

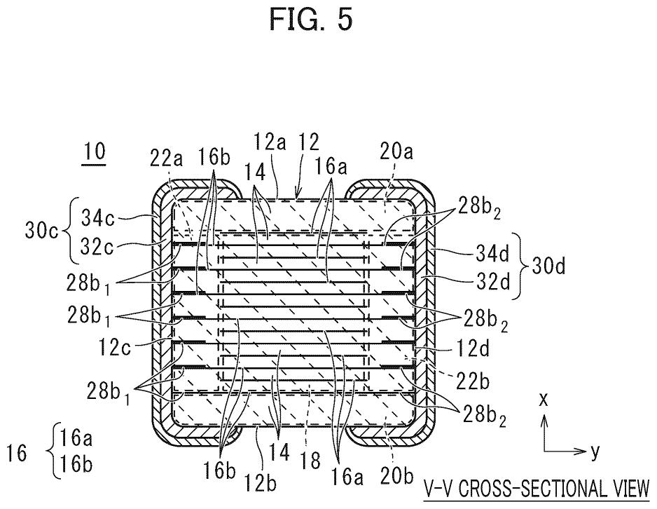

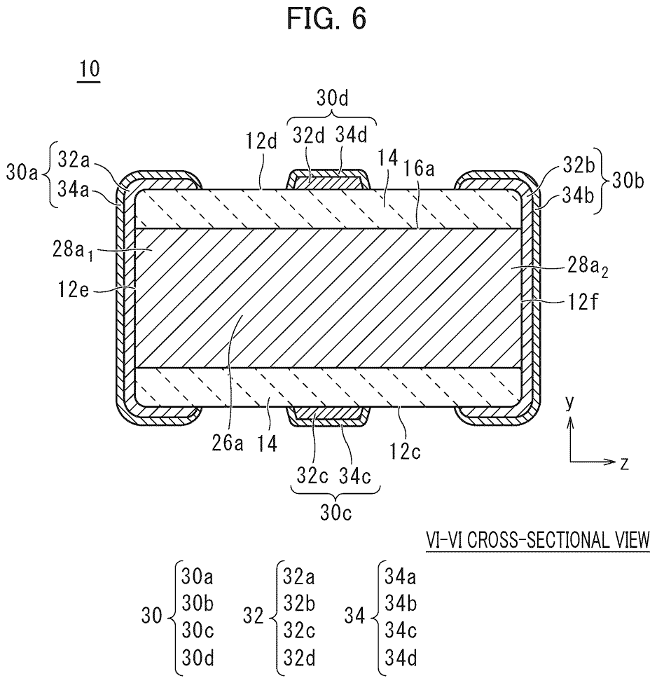

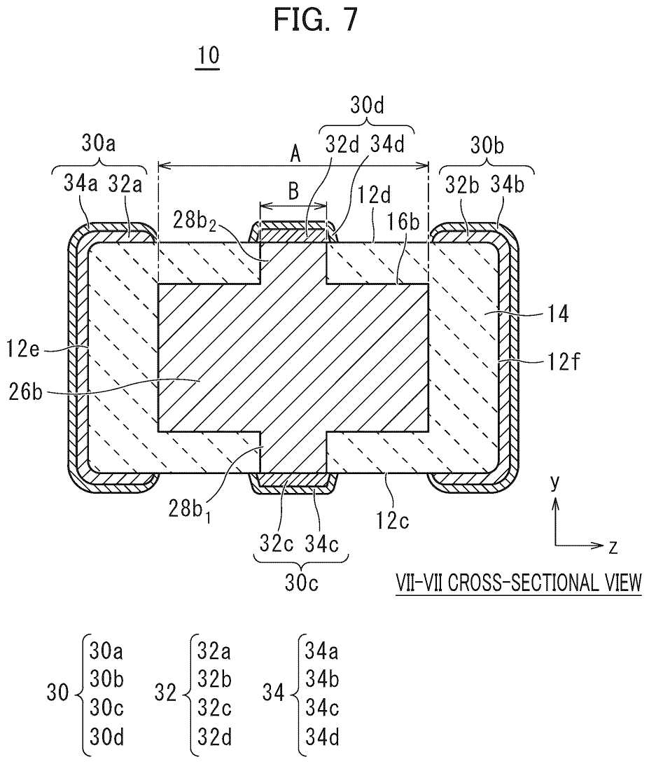

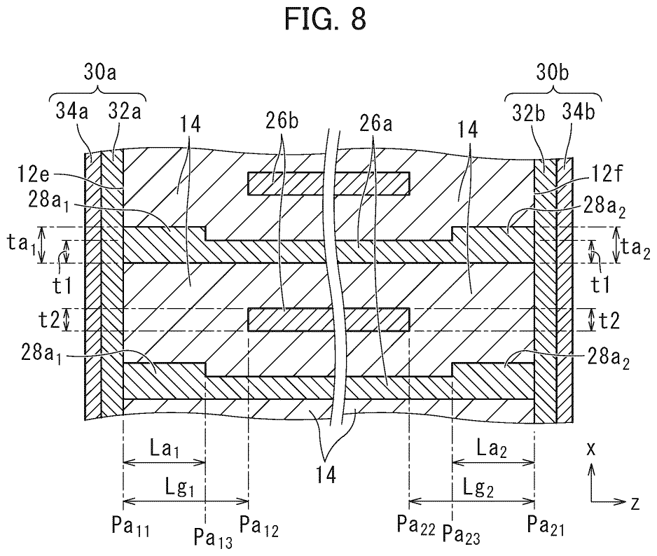

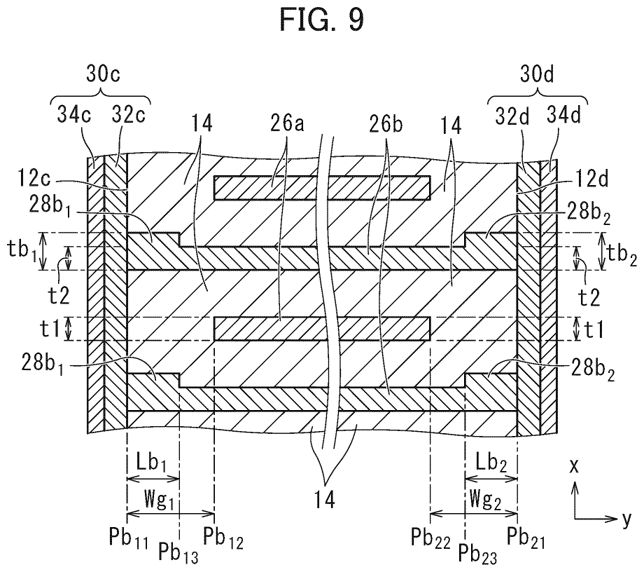

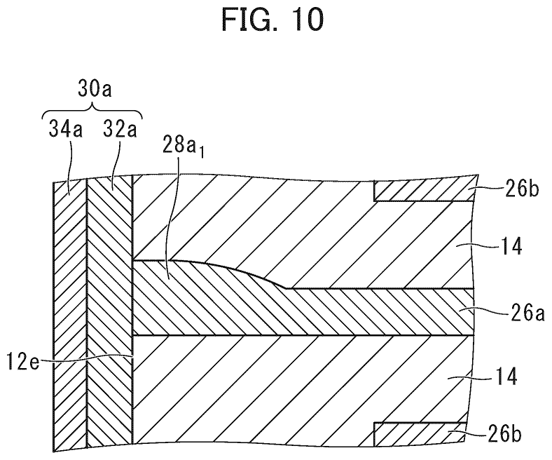

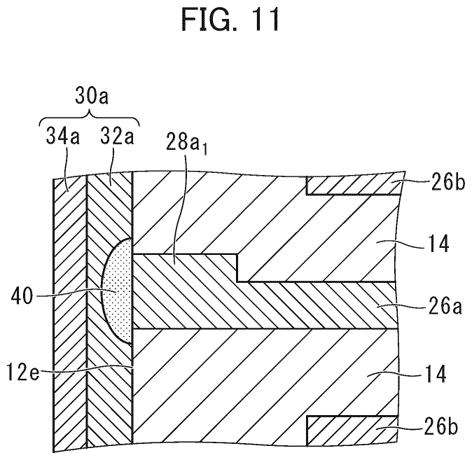

FIG. 1 is an external perspective view showing an example of a three-terminal multilayer ceramic capacitor according to an example embodiment of the present invention. FIG. 2 is a top view showing an example of a three-terminal multilayer ceramic capacitor according to an example embodiment of the present invention. FIG. 3 is a front view showing an example of a three-terminal multilayer ceramic capacitor according to an example embodiment of the present invention. FIG. 4 is a cross-sectional view taken along the line IV-IV in FIG. 1. FIG. 5 is a cross-sectional view taken along the line V-V in FIG. 1. FIG. 6 is a cross-sectional view taken along the line VI-VI in FIG. 4. FIG. 7 is a cross-sectional view taken along the line VII-VII in FIG. 4. FIG. 8 is a schematic enlarged view of a portion of FIG. 4. FIG. 9 is a schematic enlarged view of a portion of FIG. 5. FIG. 10 is a schematic enlarged view of another example embodiment of the present invention of FIG. 4. FIG. 11 is a schematic enlarged view showing a diffusion state of Ni.

As shown in FIG. 1, a three-terminal multilayer ceramic capacitor 10 includes, for example, a rectangular or substantially rectangular parallelepiped multilayer body 12 and external electrodes 30.

The multilayer body 12 includes a plurality of laminated ceramic layers 14 and a plurality of laminated internal electrode layers 16, each on a corresponding one of the plurality of ceramic layers 14. The ceramic layers 14 and the internal electrode layers 16 are laminated in the height direction x.

The multilayer body 12 includes a first main surface 12a and a second main surface 12b opposed to each other in the height direction x, a first lateral surface 12c and a second lateral surface 12d opposed to each other in the width direction y orthogonal or substantially orthogonal to the height direction x, and a first end surface 12e and a second end surface 12f opposed to each other in the length direction z orthogonal or substantially orthogonal to the height direction x and the width direction y. The multilayer body 12 includes rounded corner portions and rounded ridge portions. In addition, the corner portion refers to a portion where three adjacent surfaces of the multilayer body intersect, and the ridge portion refers to a portion where two adjacent surfaces of the multilayer body intersect. In addition, unevenness and the like may be provided on a portion or all of the first main surface 12a and the second main surface 12b, the first lateral surface 12c and the second lateral surface 12d, and the first end surface 12e and the second end surface 12f. In addition, the dimension L of the multilayer body 12 in the length direction z is not necessarily longer than the dimension W in the width direction y.

The multilayer body 12 includes an inner layer portion 18, and a first main surface-side outer layer portion 20a and a second main surface-side outer layer portion 20b that sandwich the inner layer portion 18 in the lamination direction.

The inner layer portion 18 includes a plurality of ceramic layers 14 and a plurality of internal electrode layers 16. The inner layer portion 18 includes an internal electrode layer 16 located closest to the first main surface 12a to an internal electrode layer 16 located closest to the second main surface 12b in the lamination direction. The internal electrode layers 16 include first internal electrode layers 16a each extending toward the first end surface 12e and the second end surface 12f, and second internal electrode layers 16b each extending toward the first lateral surface 12c and the second lateral surface 12d. In the inner layer portion 18, a plurality of the first internal electrode layers 16a and a plurality of the second internal electrode layers 16b are opposed to each other with a corresponding one of the ceramic layers 14 interposed therebetween. The inner layer portion 18 is a portion that generates capacitance and substantially defines and functions as a capacitor.

The first main surface-side outer layer portion 20a is located adjacent to the first main surface 12a, and includes a plurality of ceramic layers 14 located between the first main surface 12a, and the outermost surface of the inner layer portion 18 adjacent to the first main surface 12a and one straight line of the outermost surface (an extension line from the outermost surface to the first lateral surface 12c, the second lateral surface 12d, the first end surface 12e, and the second end surface 12f). That is, the first main surface-side outer layer portion 20a is an aggregate of the plurality of ceramic layers 14 located between the first main surface 12a and the internal electrode layer 16 closest to the first main surface 12a. The ceramic layers 14 used in the first main surface-side outer layer portion 20a may be the same as the ceramic layers 14 used in the inner layer portion 18. Similarly, the second main surface-side outer layer portion 20b includes a plurality of ceramic layers 14 located adjacent to the second main surface 12b and located between the second main surface 12b, and the outermost surface of the inner layer portion 18 adjacent to the second main surface 12b and one straight line of the outermost surface (an extension line from the outermost surface to the first lateral surface 12c, the second lateral surface 12d, the first end surface 12e, and the second end surface 12f). That is, the second main surface-side outer layer portion 20b is an aggregate of the plurality of ceramic layers 14 located between the second main surface 12b and the internal electrode layer 16 closest to the second main surface 12b. The ceramic layers 14 used in the second main surface-side outer layer portion 20b may be the same as the ceramic layers 14 used in the inner layer portion 18.

In addition, the multilayer body 12 includes a first lateral surface-side outer layer portion 22a which is located adjacent to the first lateral surface 12c and includes a plurality of ceramic layers 14 located between the first lateral surface 12c and the outermost surface of the inner layer portion 18 adjacent to the first lateral surface 12c. Similarly, the multilayer body 12 includes a second lateral surface-side outer layer portion 22b which is located adjacent to the second lateral surface 12d and includes a plurality of ceramic layers 14 located between the second lateral surface 12d and the outermost surface of the inner layer portion 18 adjacent to the second lateral surface 12d. In addition, the first lateral surface-side outer layer portion 22a and the second lateral surface-side outer layer portion 22b are also referred to as W gaps or side gaps.

Further, the multilayer body 12 includes a first end surface-side outer layer portion 24a which is located adjacent to the first end surface 12e and includes a plurality of ceramic layers 14 located between the first end surface 12e and the outermost surface of the inner layer portion 18 adjacent to the first end surface 12e. Similarly, the multilayer body 12 includes a second end surface-side outer layer portion 24b which is located adjacent to the second end surface 12f and includes a plurality of ceramic layers 14 located between the second end surface 12f and the outermost surface of the inner layer portion 18 adjacent to the second end surface 12f. In addition, the first end surface-side outer layer portion 24a and the second end surface-side outer layer portion 24b are also referred to as L gaps or end gaps.

The dimensions of the multilayer body 12 are not particularly limited.

The ceramic layers 14 can be made of, for example, a dielectric material as the ceramic material. As such a dielectric material, for example, dielectric ceramic including a component such as BaTiO₃, CaTiO₃, SrTiO₃, or CaZrO₃ can be used. In a case where the dielectric material is included as a main component, a subcomponent with a lower content than the main component, such as, for example, a Mn compound, a Fe compound, a Cr compound, a Co compound, or a Ni compound, may be added according to the desired characteristics of the multilayer body 12.

The thickness of each ceramic layer 14 after firing is preferably, for example, about 0.3 μm or more and about 5.0 μm or less. The number of laminated ceramic layers 14 is preferably, for example, 75 or more and 1500 or less. In addition, the number of the ceramic layers 14 is the total number of the number of the ceramic layers 14 of the inner layer portion 18 and the number of the ceramic layers 14 of the first main surface-side outer layer portion 20a and the second main surface-side outer layer portion 20b.

The multilayer body 12 includes a plurality of the first internal electrode layers 16a and a plurality of the second internal electrode layers 16b as the plurality of internal electrode layers 16. The plurality of first internal electrode layers 16a are provided on the plurality of ceramic layers 14 and extend toward the first end surface 12e and the second end surface 12f. The plurality of second internal electrode layers 16b are provided on the plurality of ceramic layers 14 and extend toward the first lateral surface 12c and the second lateral surface 12d. The plurality of first internal electrode layers 16a and the plurality of second internal electrode layers 16b may be alternately laminated via a corresponding one of the ceramic layers 14, or after a plurality of ceramic layers 14 in which the first internal electrode layers 16a are provided are laminated, the ceramic layers 14 in which the second internal electrode layers 16b are provided may be laminated. In this way, it is possible to change the lamination pattern according to the desired capacitance value.

As shown in FIG. 6, each of the first internal electrode layers 16a includes a first counter electrode portion 26a opposed to the second internal electrode layers 16b, a first extension electrode portion 28a1 extending from the first counter electrode portion 26a toward the surface of the first end surface 12e of the multilayer body 12, and a second extension electrode portion 28a2 extending from the first counter electrode portion 26a toward the surface of the second end surface 12f of the multilayer body 12. Specifically, the first extension electrode portion 28a1 is exposed on the surface of the first end surface 12e of the multilayer body 12, and the second extension electrode portion 28a2 is exposed on the surface of the second end surface 12f of the multilayer body 12. Therefore, each of the first internal electrode layers 16a is not exposed on the surfaces of the first lateral surface 12c or the second lateral surface 12d of the multilayer body 12. The first extension electrode portion 28a₁ is connected to the first external electrode 30a, and the second extension electrode portion 28a₂ is connected to the second external electrode 30b.

The shape of the first counter electrode portion 26a and the shapes of the first extension electrode portion 28a₁ and the second extension electrode portion 28a₂ are not particularly limited, but are preferably rectangular or substantially rectangular. However, the corner portions may be rounded.

In addition, the lengths of the first extension electrode portion 28a₁ and the second extension electrode portion 28a₂ in the width direction y may be equal to or shorter than the length of the first counter electrode portion 26a in the width direction y. In addition, the shapes of the first extension electrode portion 28a₁ and the second extension electrode portion 28a₂ may be tapered.

As shown in FIG. 7, each of the second internal electrode layers 16b has a substantially cross shape, and includes a second counter electrode portion 26b opposed to the first counter electrode portion 26a, a third extension electrode portion 28b₁ extending from the second counter electrode portion 26b toward the surface of the first lateral surface 12c of the multilayer body 12, and a fourth extension electrode portion 28b₂ extending from the second counter electrode portion 26b toward the surface of the second lateral surface 12d of the multilayer body 12. Specifically, the third extension electrode portion 28b₁ is exposed on the surface of the first lateral surface 12c of the multilayer body 12, and the fourth extension electrode portion 28b₂ is exposed on the surface of the second lateral surface 12d of the multilayer body 12. Therefore, the second internal electrode layer 16b is not exposed on the surface of the first end surface 12e or the surface of the second end surface 12f of the multilayer body 12. The third extension electrode portion 28b₁ is connected to the third external electrode 30c, and the fourth extension electrode portion 28b₂ is connected to the fourth external electrode 30d.

The shape of the second counter electrode portion 26b and the shapes of the third extension electrode portion 28b₁ and the fourth extension electrode portion 28b₂ are preferably rectangular or substantially rectangular. However, the corner portions may be rounded.

The relationship between the dimension A in the length direction z between the side of the second counter electrode portion 26b adjacent to the first end surface 12e and the side adjacent to the second end surface 12f and the dimension B in the length direction z between the side adjacent to the first end surface 12e and the side adjacent to the second end surface 12f of the third extension electrode portion 28b₁ and the fourth extension electrode portion 28b₂ is preferably A≥B.

The shape of the third extension electrode portion 28b₁ may be a tapered shape having a narrower width as it approaches the first lateral surface 12c, and the shape of the fourth extension electrode portion 28b₂ may be a tapered shape having a narrower width as it approaches the second lateral surface 12d.

Here, the thickness relationship is such that the thickness tb₁ of the third extension electrode portion 28b₁ in the height direction x and the thickness tb₂ of the fourth extension electrode portion 28b₂ in the height direction x>the thickness ta₁ of the first extension electrode portion 28a₁ in the height direction x and the thickness ta₂ of the second extension electrode portion 28a₂ in the height direction x≥at least one of the thickness t1 of the first counter electrode portion 26a in the height direction x or the thickness t2 of the second counter electrode portion 26b in the height direction x. The thickness of at least one of the thickness t1 or the thickness t2 may be only the thickness t1, only the thickness t2, or both the thickness t1 and the thickness t2.

As shown in FIG. 8, the thickness ta₁ refers to a thickness at any point in the length direction z from a starting point Pa₁₃ at which the thickness of the first counter electrode portion 26a starts to increase to an end point Pan (which is also a position of the first end surface 12e) exposed on the first end surface 12e. The thickness ta₂ refers to a thickness at any point in the length direction z from a starting point Pa₂₃ at which the thickness of the first counter electrode portion 26a starts to increase to an end point Pa₂₁ (which is also a position of the second end surface 12f) exposed on the second end surface 12f. As shown in FIG. 9, the thickness tb₁ refers to a thickness at any point in the width direction y from a starting point Pb₁₃ at which the thickness of the second counter electrode portion 26b starts to increase to an end point Pb₁₁ (which is also a position of the first lateral surface 12c) exposed on the first lateral surface 12c. The thickness tb₂ refers to a thickness at any point in the width direction y from a starting point Pb₂₃ at which the thickness of the second counter electrode portion 26b starts to increase to an end point Pb₂₁ (which is also a position of the second lateral surface 12d) exposed on the second lateral surface 12d. In addition, the thicknesses ta₁ and ta₂ are not limited thereto, but are thicknesses in the LT cross section at a position of about W/2 when, for example, the dimension in the width direction y of the three-terminal multilayer ceramic capacitor 10 is defined as W. In addition, the thicknesses t1, t2, tb₁, and tb₂ are not limited thereto, but are thicknesses in the WT cross section at a position of about L/2 when, for example, the dimension in the length direction z of the three-terminal multilayer ceramic capacitor 10 is defined as L.

The thickness ta₁ of the first extension electrode portion 28a₁ and the thickness ta₂ of the second extension electrode portion 28a₂ are each preferably about 1.0 times or more and about 1.3 times or less than the t1 of the first counter electrode portion 26a, for example. It can also be said that the thickness ta₁ of the first extension electrode portion 28a₁ and the thickness ta₂ of the second extension electrode portion 28a₂ are each preferably about 1.0 times or more and about 1.3 times or less than the of at least one of the thickness t1 of the first counter electrode portion 26a or the thickness t2 of the second counter electrode portion 26b, for example. In addition, the thickness tb₁ of the third extension electrode portion 28b₁ and the thickness tb₂ of the fourth extension electrode portion 28b₂ are preferably about 1.3 times or more and about 1.7 times or less than the t2 of the second counter electrode portion 26b, for example. It can also be said that the thickness tb₁ of the third extension electrode portion 28b₁ and the thickness tb₂ of the fourth extension electrode portion 28b₂ are each preferably 1.3 times or more and 1.7 times or less than the of at least one of the thickness t1 of the first counter electrode portion 26a or the thickness t2 of the second counter electrode portion 26b, for example.

In the present example embodiment, the first extension electrode portion 28a₁ and the second extension electrode portion 28a₂ each increase in thickness toward the first main surface 12a with respect to the first counter electrode portion 26a. Further, the thicknesses ta₁ and ta₂ respectively increase in one step with respect to the thicknesses t1 and t2, and the upper surfaces of the portions of the thicknesses ta₁ and ta₂ are provided along the first main surface 12a and the second main surface 12b. Similarly, the third extension electrode portion 28b₁ and the fourth extension electrode portion 28b₂ each increase in thickness toward the first main surface 12a with respect to the second counter electrode portion 26b. Further, the thicknesses tb₁ and tb₂ respectively increase in one step with respect to the thicknesses t1 and t2, and the upper surfaces of the portions of the thicknesses tb₁ and tb₂ are provided along the first main surface 12a and the second main surface 12b.

In addition, the shapes of the first extension electrode portion 28a₁, the second extension electrode portion 28a₂, the third extension electrode portion 28b₁, and the fourth extension electrode portion 28b₂ are not limited as long as the thickness is large at least on the exposed surface from the multilayer body 12, and may be, for example, a shape in which the thickness gradually increases toward the end surfaces 12e and 12f or the lateral surfaces 12c and 12d. Specifically, as shown in FIG. 10, the thickness of the first extension electrode portion 28a₁ gradually becomes larger than that of the first counter electrode portion 26a toward the first end surface 12e. In addition, the first extension electrode portion 28a₁, the second extension electrode portion 28a₂, the third extension electrode portion 28b₁, and the fourth extension electrode portion 28b₂ are not limited to a shape having a larger thickness on the side adjacent to the first main surface 12a than the first counter electrode portion 26a and the second counter electrode portion 26b, and may have a shape having a larger thickness on the side adjacent to the second main surface 12b or may have a larger thickness toward both the first main surface 12a and the second main surface 12b.

In addition, the thickness ta₁ of the first extension electrode portion 28a₁ is required to be large at least at the first end surface 12e, and the distance La₁ (the distance from the end point Pan to the starting point Pa₁₃) in the length direction z of the portion of the thickness ta₁ of the first extension electrode portion 28a₁ is not limited. For example, the distance La₁ may be the same or substantially the same as the distance Lg₁ of the L gap (the distance from the end point Pan to the point Pa₁₂ at the end of the second internal electrode layer 16b adjacent to the first end surface 12e). Unlike this, for example, the distance La₁ may be smaller than the distance Lg₁ of the L gap. In this case, since the portion of the thickness ta₁ of the first extension electrode portion 28a₁ does not overlap the second counter electrode portion 26b, it is possible to reduce or prevent an increase in the dimension in the height direction x of the three-terminal multilayer ceramic capacitor 10. Unlike this, the portion of the thickness ta₁ may extend toward the second end surface 12f to a position overlapping the second counter electrode portion 26b.

Similarly, the thickness ta₂ of the second extension electrode portion 28a₂ is required to be large at least at the second end surface 12f, and the distance La₂ (the distance from the end point Pa₂₁ to the starting point Pa₂₃) in the length direction z of the portion of the thickness ta₂ of the second extension electrode portion 28a₂ is not limited. For example, the distance La₂ may be the same or substantially the same as the distance Lg₂ of the L gap (the distance from the end point Pa₂₁ to a point Pa₂₂ at the end of the second internal electrode layer 16b adjacent to the second end surface 12f). Unlike this, for example, the distance La₂ may be smaller than the distance Lg₂ of the L gap. In this case, since the portion of the thickness ta₂ of the second extension electrode portion 28a₂ does not overlap the second counter electrode portion 26b, it is possible to reduce or prevent an increase in the dimension in the height direction x of the three-terminal multilayer ceramic capacitor 10. Unlike this, the portion of the thickness ta₂ may extend toward the first end surface 12e to a position overlapping the second counter electrode portion 26b.

The thickness tb₁ of the third extension electrode portion 28b₁ is required to be large at least on the first lateral surface 12c, and the distance Lb₁ (the distance from the end point Pb₁₁ to the starting point Pb₁₃) in the width direction y of the portion of the thickness tb₁ of the third extension electrode portion 28b₁ is not limited. For example, the distance Lb₁ may be the same or substantially the same as the distance Wg₁ of the W gap (the distance from the end point Pb₁₁ to the point Pb₁₂ at the end of the first internal electrode layer 16a adjacent to the first lateral surface 12c). Unlike this, for example, the distance Wg₁ may be smaller than the distance Wg₁ of the W gap. In this case, since the portion of the thickness tb₁ of the third extension electrode portion 28b₁ does not overlap the first counter electrode portion 26a, it is possible to reduce or prevent an increase in the dimension in the height direction x of the three-terminal multilayer ceramic capacitor 10. Unlike this, the portion of the thickness tb₁ may extend toward the second lateral surface 12d to a position overlapping the first counter electrode portion 26a.

Similarly, the thickness tb₂ of the fourth extension electrode portion 28b₂ is required to be large at least on the second lateral surface 12d, and the distance Lb₂ (the distance from the end point Pb₂₁ to the starting point Pb₂₃) in the width direction y of the portion of the thickness tb₂ of the fourth extension electrode portion 28b₂ is not limited. For example, the distance Lb₂ may be the same or substantially the same as the distance Wg₂ of the W gap (the distance from the end point Pb₁₁ to a point Pb₂₂ at the end of the first internal electrode layer 16a adjacent to the second lateral surface 12d). Unlike this, for example, the distance Lb₂ may be smaller than the distance Wg₂ of the W gap. In this case, since the portion of the thickness tb₂ of the fourth extension electrode portion 28b₂ does not overlap the first counter electrode portion 26a, it is possible to reduce or prevent an increase in the dimension in the height direction x of the three-terminal multilayer ceramic capacitor 10. Unlike this, the portion of the thickness tb₂ may extend toward the first lateral surface 12c to a position overlapping the first counter electrode portion 26a.

As long as the above thickness relationship is satisfied, the thickness ta₁ of the first extension electrode portion 28a₁ and the thickness ta₂ of the second extension electrode portion 28a₂ are not necessarily the same or substantially the same. Similarly, the thickness tb₁ of the third extension electrode portion 28b₁ and the thickness tb₂ of the fourth extension electrode portion 28b₂ are not necessarily the same or substantially the same. Similarly, the thickness t1 of the first counter electrode portion 26a and the thickness t2 of the second counter electrode portion 26b are not necessarily the same or substantially the same.

The first extension electrode portion 28a₁ is connected to the first external electrode 30a, and Ni in the first extension electrode portion 28a₁ and Cu in the first external electrode 30a are mutually diffused. That is, for example, Ni included in the first extension electrode portion 28a₁ diffuses into the first external electrode 30a, and Cu included in the first external electrode 30a diffuses into the first extension electrode portion 28a₁. Referring to FIG. 11, the first external electrode 30a includes a first base electrode layer 32a and a first plated layer 34a, and Ni included in the first extension electrode portion 28a₁ is diffused into the first external electrode 30a such that a diffusion region 40 is provided. The interdiffusion between the other extension electrode portions 28a₂, 28b₁, 28b₂ and the external electrodes 30a, 30b is the same, such that the diffusion region 40 is provided.

Here, for example, a region in which the Ni content is about 10% or more with respect to the total of the Ni content and the Cu content is defined as the Ni diffusion region 40. In this case, the second Ni diffusion distance in the width direction y of Ni from the third extension electrode portion 28b₁ and the fourth extension electrode portion 28b₂ to the third external electrode 30c and the fourth external electrode 30d with reference to the first lateral surface 12c and the second lateral surface 12d of the multilayer body 12 is preferably, for example, about 1.05 times or more and about 1.4 times or less the first Ni diffusion distance in the length direction z of Ni from the first extension electrode portion 28a₁ and the second extension electrode portion 28a₂ to the first external electrode 30a and the second external electrode 30b with reference to the first end surface 12e and the second end surface 12f of the multilayer body 12.

In addition, the multilayer body 12 includes a counter electrode portion region 27. The counter electrode portion region 27 refers to a portion where the first counter electrode portion 26a of the first internal electrode layer 16a and the second counter electrode portion 26b of the second internal electrode layer 16b are opposed to each other. The counter electrode portion region 27 is configured as a portion of the inner layer portion 18. In addition, the counter electrode portion region 27 is also referred to as a capacitor effective portion.

It is possible to configure the first internal electrode layers 16a and the second internal electrode layers 16b of, for example, a suitable electrically conductive material such as a metal including Ni as a main component, Cu, Ag, Pd, or Au, or an alloy including at least one of these metals, such as an Ag—Pd alloy.

The number of the first internal electrode layers 16a and the second internal electrode layers 16b is not particularly limited, but is preferably, for example, 10 or more and 2000 or less in total.

The thickness of each first internal electrode layer 16a is not particularly limited, but is preferably, for example, about 0.30 μm or more and about 1.0 μm or less. The thickness of each second internal electrode layer 16b is not particularly limited, but is preferably, for example, about 0.30 μm or more and about 1.0 μm or less.

The external electrodes 30 are provided on the first end surface 12e and the second end surface 12f, the first lateral surface 12c and the second lateral surface 12d, and the first main surface 12a and the second main surface 12b of the multilayer body 12.

The external electrodes 30 include a first external electrode 30a, a second external electrode 30b, a third external electrode 30c, and a fourth external electrode 30d.

The first external electrode 30a is connected to the first internal electrode layers 16a and is provided on the surface of the first end surface 12e. In addition, in the present example embodiment, the first external electrode 30a extends from the first end surface 12e of the multilayer body 12 and is also provided on a portion of the first main surface 12a and a portion of the second main surface 12b, and a portion of the first lateral surface 12c and a portion of the second lateral surface 12d. In this case, the first external electrode 30a is electrically connected to the first extension electrode portions 28a₁ of the first internal electrode layers 16a. In addition, the first external electrode 30a may be provided only on the surface of the first end surface 12e.

The second external electrode 30b is connected to the first internal electrode layers 16a and is provided on the surface of the second end surface 12f. In addition, in the present example embodiment, the second external electrode 30b extends from the second end surface 12f of the multilayer body 12 and is also provided on a portion of the first main surface 12a and a portion of the second main surface 12b, and a portion of the first lateral surface 12c and a portion of the second lateral surface 12d. In this case, the second external electrode 30b is electrically connected to the second extension electrode portions 28a₂ of the first internal electrode layers 16a. In addition, the second external electrode 30b may be provided only on the surface of the second end surface 12f.

The third external electrode 30c is connected to the second internal electrode layers 16b and is provided on the surface of the first lateral surface 12c. In addition, in the present example embodiment, the third external electrode 30c extends from the first lateral surface 12c of the multilayer body 12 and is also provided on a portion of the first main surface 12a and a portion of the second main surface 12b. In this case, the third external electrode 30c is electrically connected to the third extension electrode portions 28b₁ of the second internal electrode layers 16b. In addition, the third external electrode 30c may be provided only on the surface of the first lateral surface 12c.

The fourth external electrode 30d is connected to the second internal electrode layers 16b and is provided on the surface of the second lateral surface 12d. In addition, in the present example embodiment, the fourth external electrode 30d extends from the second lateral surface 12d of the multilayer body 12 and is also provided on a portion of the first main surface 12a and a portion of the second main surface 12b. In this case, the fourth external electrode 30d is electrically connected to the fourth extension electrode portions 28b₂ of the second internal electrode layers 16b. In addition, the fourth external electrode 30d may be provided only on the surface of the second lateral surface 12d.

In the multilayer body 12, the first counter electrode portion 26a of the first internal electrode layers 16a and the second counter electrode portion 26b of the second internal electrode layers 16b are opposed to each other with the ceramic layers 14 interposed therebetween, such that capacitance is generated. Therefore, it is possible to obtain capacitance between the first external electrode 30a and the second external electrode 30b to which the first internal electrode layers 16a are connected, and the third external electrode 30c and the fourth external electrode 30d to which the second internal electrode layers 16b are connected, such that characteristics of the capacitor are provided.

The external electrodes 30 each include a base electrode layer 32 including a metal component and a glass component, and a plated layer 34 provided on a surface of the base electrode layer 32.

The base electrode layer 32 includes a first base electrode layer 32a, a second base electrode layer 32b, a third base electrode layer 32c, and a fourth base electrode layer 32d.

The first base electrode layer 32a is connected to the first internal electrode layers 16a and is provided on the surface of the first end surface 12e. In addition, the first base electrode layer 32a extends from the first end surface 12e and is also provided on a portion of the first main surface 12a and a portion of the second main surface 12b, and a portion of the first lateral surface 12c and a portion of the second lateral surface 12d. In addition, the first base electrode layer 32a may be provided only on the surface of the first end surface 12e. The second base electrode layer 32b is connected to the first internal electrode layers 16a and is provided on the surface of the second end surface 12f. In addition, the second base electrode layer 32b extends from the second end surface 12f and is also provided on a portion of the first main surface 12a and a portion of the second main surface 12b, and a portion of the first lateral surface 12c and a portion of the second lateral surface 12d. In addition, the second base electrode layer 32b may be provided only on the surface of the second end surface 12f.

The third base electrode layer 32c is connected to the second internal electrode layers 16b and is provided on the surface of the first lateral surface 12c. In addition, the third base electrode layer 32c extends from the first lateral surface 12c and is also provided on a portion of the first main surface 12a and a portion of the second main surface 12b. In addition, the third base electrode layer 32c may be provided only on the surface of the first lateral surface 12c. The fourth base electrode layer 32d is connected to the second internal electrode layers 16b and is provided on the surface of the second lateral surface 12d. In addition, the fourth base electrode layer 32d extends from the second lateral surface 12d and is also provided on a portion of the first main surface 12a and a portion of the second main surface 12b. In addition, the fourth base electrode layer 32d may be provided only on the surface of the second lateral surface 12d.

The base electrode layer 32 includes at least one of a fired layer, an electrically conductive resin layer, a thin film layer, or the like. In addition, in the Experimental Examples described later, the base electrode layer 32 is a fired layer. Hereinafter, each configuration in the case where the base electrode layer 32 is the fired layer, electrically conductive resin layer, or thin film layer will be described.

The fired layer includes a glass component and a metal component. The glass component of the fired layer includes at least one of, for example, B, Si, Ba, Mg, Al, Li, or the like. As the metal component of the fired layer, for example, Cu is a main component, and at least one of Ni, Ag, Pd, an Ag—Pd alloy, Au, or the like is included. The fired layer is formed by applying an electrically conductive paste including a glass component and a metal component to the multilayer body 12, and firing the paste. The fired layer may be formed by simultaneously firing the multilayer chip including the internal electrode layers 16 and the ceramic layers 14 and the electrically conductive paste applied to the multilayer chip, or may be formed by firing the multilayer chip including the internal electrode layers 16 and the ceramic layers 14 to obtain the multilayer body 12, and then firing the electrically conductive paste on the multilayer body 12. In addition, when the multilayer chip including the internal electrode layers 16 and the ceramic layers 14 and the electrically conductive paste applied to the multilayer chip are fired at the same time, it is preferable that the fired layer is formed by firing a material to which a dielectric material is added, instead of a glass component. The fired layer may include a plurality of layers.

In addition, when the base electrode layer 32 includes a dielectric material instead of a glass component, it is possible to improve the adhesion between the multilayer body 12 and the base electrode layer 32. In addition, the base electrode layer 32 may include both a glass component and a dielectric component.

As the dielectric material included in the base electrode layer 32, the same type of dielectric material as the ceramic layers 14 may be used, or a different type of dielectric material may be used. The dielectric component includes, for example, at least one of BaTiO₃, CaTiO₃, (Ba,Ca)TiO₃, SrTiO₃, CaZrO₃, or the like.

When the first and second base electrode layers 32a and 32b include fired layers, the thickness in the length direction z from the first end surface 12e or the second end surface 12f is preferably, for example, about 3 μm or more and about 20 μm or less. In addition, when the third and fourth base electrode layers 32c and 32d include fired layers, the thickness in the width direction y from the first lateral surface 12c or the second lateral surface 12d is preferably, for example, about 3 μm or more and about 20 μm or less.

When the electrically conductive resin layer is provided as the base electrode layer 32, the electrically conductive resin layer may be provided on the fired layer so as to cover the fired layer, or may be provided directly on the multilayer body 12 without providing the fired layer. The electrically conductive resin layer includes a metal such as, for example, electrically conductive particles and a thermosetting resin. The electrically conductive resin layer may completely cover the base electrode layer or may partially cover the base electrode layer.

Since the electrically conductive resin layer includes a thermosetting resin, the electrically conductive resin layer is more flexible than an electrically conductive layer made of, for example, a plating film or a fired product of an electrically conductive paste. For this reason, even when a physical shock or a shock due to a thermal cycle is applied to the three-terminal multilayer ceramic capacitor 10, the electrically conductive resin layer defines and functions as a buffer layer, and it is possible to reduce or prevent cracks in the three-terminal multilayer ceramic capacitor 10.

As the metal included in the electrically conductive resin layer, it is possible to use, for example, Ag, Ni, Sn, Bi, or an alloy including Cu as a main component. In addition, for example, it is also possible to use a metal powder obtained by coating the surface of the metal powder with Ag. When an Ag-coated metal powder is used, it is preferable to use, for example, Cu, Ni, Sn, Bi, or an alloy powder thereof as the metal powder. The reason why the electrically conductive metal powder of Ag is used as the electrically conductive metal is that Ag is suitable for an electrode material because having the lowest specific resistance among metals, and Ag is a noble metal and thus will not oxidize and has high weather resistance. This is because it is possible to make the metal of the base material inexpensive while maintaining the above-described characteristics of Ag.

Further, for example, as the metal included in the electrically conductive resin layer, it is also possible to use a metal obtained by subjecting Cu or Ni to an antioxidant treatment. In addition, for example, as the metal included in the electrically conductive resin layer, it is also possible to use a metal powder obtained by coating the surface of the metal powder with Sn, Ni, or Cu. When a metal powder coated with Sn, Ni, or Cu is used, it is preferable to use, for example, Ag, Cu, Ni, Sn, Bi, or an alloy powder thereof as the metal powder.

The metal included in the electrically conductive resin layer mainly provides the electrical conductivity of the electrically conductive resin layer. Specifically, when the electrically conductive fillers are in contact with each other, a conduction path is provided inside the electrically conductive resin layer.

As the metal included in the electrically conductive resin layer, it is possible to use a metal having a spherical shape, a metal having a flat shape, or the like, and it is preferable to use a mixture of a spherical metal powder and a flat metal powder.

As the resin of the electrically conductive resin layer, for example, it is possible to use various known thermosetting resins such as, for example, an epoxy resin, a phenoxy resin, a phenol resin, a urethane resin, a silicone resin, or a polyimide resin. Among them, an epoxy resin excellent in heat resistance, moisture resistance, adhesion, and the like is one of the preferable resins.

In addition, the electrically conductive resin layer preferably includes a curing agent together with a thermosetting resin. When an epoxy resin is used as the base resin, it is possible to use various known compounds such as, for example, phenol-based, amine-based, acid anhydride-based, imidazole-based, active ester-based, or amide-imide-based compounds as the curing agent of the epoxy resin.

The electrically conductive resin layer may include a plurality of layers.

When a thin film layer is provided as the base electrode layer 32, the thin film layer is formed by a thin film forming method such as, for example, a sputtering method or a vapor deposition method, and is a layer having a thickness of, for example, about 1 μm or less on which metal particles are deposited.

The plated layer 34 includes a first plated layer 34a, a second plated layer 34b, a third plated layer 34c, and a fourth plated layer 34d. The first plated layer 34a, the second plated layer 34b, the third plated layer 34c, and the fourth plated layer 34d, which are the plated layers 34 that can be provided on the base electrode layer 32, will be described with reference to FIGS. 4 and 5. The first plated layer 34a, the second plated layer 34b, the third plated layer 34c, and the fourth plated layer 34d include, for example, at least one of Cu, Ni, Sn, Ag, Pd, an Ag—Pd alloy, Au, or the like.

The first plated layer 34a is provided so as to cover the first base electrode layer 32a. The second plated layer 34b is provided so as to cover the second base electrode layer 32b. The third plated layer 34c is provided so as to cover the third base electrode layer 32c. The fourth plated layer 34d is provided so as to cover the fourth base electrode layer 32d.

The first plated layer 34a, the second plated layer 34b, the third plated layer 34c, and the fourth plated layer 34d may include a plurality of layers. In this case, it is preferable that the plated layer 34 has a two-layer configuration including, for example, a lower plated layer provided on the base electrode layer 32 by Ni plating and an upper plated layer provided on the lower plated layer by Sn plating.

That is, the first plated layer 34a includes a first lower plated layer and a first upper plated layer located on the surface of the first lower plated layer. In addition, the second plated layer 34b includes a second lower plated layer and a second upper plated layer located on the surface of the second lower plated layer. Similarly, the third plated layer 34c includes a third lower plated layer and a third upper plated layer located on the surface of the third lower plated layer. In addition, the fourth plated layer 34d includes a fourth lower plated layer and a fourth upper plated layer located on the surface of the fourth lower plated layer.

The lower plated layer formed by Ni plating is used to reduce or prevent the base electrode layer 32 from being eroded by solder when the three-terminal multilayer ceramic capacitor 10 is mounted, and the upper plated layer formed by Sn plating is used to improve the wettability of solder when the three-terminal multilayer ceramic capacitor 10 is mounted and to facilitate mounting. The thickness per one plated layer is preferably, for example, about 2.0 μm or more and about 15.0 μm or less.

The dimension in the length direction z of the three-terminal multilayer ceramic capacitor 10 including the multilayer body 12 and the first to fourth external electrodes 30a to 30d is defined as an L dimension, the dimension in the height direction x is defined as a T dimension, and the dimension in the width direction y is defined as a W dimension. The dimensions of the three-terminal multilayer ceramic capacitor 10 are not particularly limited, but, for example, the L dimension in the length direction z is about 1.05 mm or more and about 1.35 mm or less, the T dimension in the height direction x is about 0.45 mm or more and about 0.90 mm or less, and the W dimension in the width direction y is about 0.60 mm or more and about 0.95 mm or less. In addition, it is possible to measure the dimensions of the three-terminal multilayer ceramic capacitor 10 by a microscope.

Next, an example or a method of manufacturing a three-terminal multilayer ceramic capacitor according to an example embodiment of the present invention will be described.

First, a dielectric sheet for manufacturing a ceramic layer and an electrically conductive paste for manufacturing an internal electrode layer are prepared. The dielectric sheet and the electrically conductive paste for manufacturing the internal electrode layer includes a binder and a solvent. The binder and the solvent may be known.

Then, an electrically conductive paste for manufacturing the internal electrode layer is printed on the dielectric sheet in a predetermined pattern by, for example, gravure printing or screen printing. With such a configuration, the dielectric sheet on which the pattern of the first internal electrode layer is formed and the dielectric sheet on which the pattern of the second internal electrode layer is formed are prepared. More specifically, for example, it is possible to separately prepare a gravure plate for printing the first internal electrode layer and a gravure for printing the second internal electrode layer, and to print a pattern of each internal electrode layer using a printing machine capable of separately printing two types of gravure. At this time, the depth of the plate is adjusted to be deeper as the thickness is larger so that the thickness relationship of the thickness in the height direction of the third extension electrode portion and the fourth extension electrode portion>the thickness in the height direction of the first extension electrode portion and the second extension electrode portion>the thickness in the height direction of at least one of the first counter electrode portion or the second counter electrode portion is satisfied. Alternatively, in order to increase the thickness, overcoating may be performed by, for example, screen printing a plurality of times. It is possible to perform the printing of the electrically conductive paste for manufacturing the internal electrode layers, for example, while conveying the dielectric sheet in the length direction z. In addition, in the Experimental Examples described below, the internal electrode layers are printed by gravure printing.

Subsequently, a predetermined number of dielectric sheets for manufacturing the outer layer on which the pattern of the internal electrode layer is not printed are laminated to form a portion defining and functioning as the second main surface-side outer layer portion on the second main surface. Then, the dielectric sheet on which the pattern of the first internal electrode layer is printed and the dielectric sheet on which the pattern of the second internal electrode layer is printed are sequentially laminated on the portion defining and functioning as the second main surface-side outer layer portion so as to have the configuration of an example embodiment of the present invention, such that the portion defining and functioning as the inner layer portion is formed. A predetermined number of dielectric sheets for manufacturing the outer layer on which the pattern of the internal electrode layer is not printed are laminated on the portion defining and functioning as the inner layer portion, such that the portion defining and functioning as the first main surface-side outer layer portion on the first main surface is formed. With such a configuration, a multilayer sheet is produced. It is possible to perform the lamination of the sheets, for example, by laminating the sheets of the upper layer while conveying the sheets of the lower layer in the length direction z.

Next, a multilayer block is produced by pressing the laminated sheet in the lamination direction by, for example, isostatic pressing or the like.

Then, the multilayer chip is cut out by cutting the multilayer block into a predetermined size. At this time, corner portions and ridge portions of the multilayer chip may be rounded by, for example, barrel polishing or the like. It is possible to perform the cutting of the multilayer block, for example, while conveying the multilayer block in the length direction z.

Subsequently, a multilayer body is produced by firing the cut-out multilayer chip. The firing temperature is preferably, for example, about 900° C. or more and about 1400° C. or less depending on the materials of the ceramic layers and the internal electrode layers.

Next, the third base electrode layer 32c of the third external electrode 30c is formed on the first lateral surface 12c of the multilayer body 12 obtained by firing, and the fourth base electrode layer 32d of the fourth external electrode 30d is formed on the second lateral surface 12d of the multilayer body 12.

When a fired layer is formed as the third base electrode layer 32c and the fourth base electrode layer 32d, an electrically conductive paste including a glass component and a metal component is applied, and then firing is performed to form a base electrode layer. The temperature of the firing treatment at this time is preferably, for example, about 700° C. or more and about 900° C. or less. In addition, in the Experimental Examples described later, the base electrode layer 32 includes a fired layer.

Here, it is possible to use various methods as a method of forming the fired layer. For example, it is possible to use a method of applying an electrically conductive paste by extruding the electrically conductive paste from a slit. In this method, by increasing the extrusion amount of the electrically conductive paste, it is possible to form the base electrode layer 32 not only on the first lateral surface 12c and the second lateral surface 12d, but also on a portion of the first main surface 12a and a portion of the second main surface 12b. In addition, for example, it is also possible to form by a roller transfer method. In the case of the roller transfer method, when the base electrode layer 32 is formed not only on the first lateral surface 12c and the second lateral surface 12d, but also on a portion of the first main surface 12a and a portion of the second main surface 12b, it is possible to form the base electrode layer 32 on a portion of the first main surface 12a and a portion of the second main surface 12b by increasing the pressing pressure during roller transfer.

In addition, for example, when the third base electrode layer 32c and the fourth base electrode layer 32d are formed of an electrically conductive resin layer, it is possible to form the electrically conductive resin layer by the following method. In addition, the electrically conductive resin layer may be formed on the surface of the fired layer, or the electrically conductive resin layer may be formed directly on the multilayer body 12 as a single body without forming the fired layer.

As an example of a method of forming the electrically conductive resin layer, an electrically conductive resin paste including a thermosetting resin and a metal component is applied onto the fired layer or the multilayer body 12, and heat treatment is performed at a temperature of, for example, about 250° C. to about 550° C. or higher to thermally cure the resin, thus forming the electrically conductive resin layer. At this time, the atmosphere during the heat treatment is preferably, for example, an N₂ atmosphere. In addition, in order to reduce or prevent scattering of the resin and oxidation of various metal components, it is preferable to reduce the oxygen concentration to about 100 ppm or less, for example.

In addition, as a method of applying the electrically conductive resin paste, for example, it is possible to use a method of applying the electrically conductive resin paste by extruding the electrically conductive resin paste through a slit or a roller transfer method in the same or substantially the same manner as the method of forming the base electrode layer 32 with the fired layer.

In addition, when the third base electrode layer 32c and the fourth base electrode layer 32d are formed as thin film layers, it is possible to form the base electrode layer by, for example, performing masking or the like and forming by a thin film forming method such as sputtering or vapor deposition at a portion where the external electrode 30 is to be formed. The base electrode layer including a thin film layer is a layer having a thickness of, for example, about 1 μm or less on which metal particles are deposited.

Next, the first base electrode layer 32a of the first external electrode 30a and the second base electrode layer 32b of the second external electrode 30b are formed on the first end surface 12e and the second end surface 12f, respectively, in the multilayer body obtained by firing. Similarly to the third base electrode layer 32c and the fourth base electrode layer 32d, in the case of forming a fired layer as the first base electrode layer 32a and the second base electrode layer 32b, an electrically conductive paste including a glass component and a metal component is applied, and then firing is performed to form a base electrode layer. The temperature of the firing treatment at this time is preferably, for example, about 700° C. or more and about 900° C. or less. As a method of applying the electrically conductive paste to both end surfaces of the multilayer body, for example, a method such as a dipping method or a screen printing method is used. In the Experimental Examples described later, the first base electrode layer 32a and the second base electrode layer 32b are formed by dipping so as to extend not only to the first end surface 12e and the second end surface 12f, but also to a portion of the first main surface 12a, a portion of the second main surface 12b, a portion of the first lateral surface 12c, and a portion of the second lateral surface 12d.

In addition, in the firing process, the third base electrode layer 32c, the fourth base electrode layer 32d, the first base electrode layer 32a, and the second base electrode layer 32b may be simultaneously fired, or may be fired on both lateral surfaces 12c and 12d and on both end surfaces 12e and 12f separately.

In addition, when the base electrode layer includes a fired layer, the fired layer may include a dielectric component. In this case, a dielectric component may be included instead of the glass component, or both of them may be included.

The dielectric component is preferably, for example, a dielectric material of the same type as the multilayer body. In addition, when a dielectric component is included in the fired layer, it is preferable that the electrically conductive paste is applied to the multilayer chip before firing, and the multilayer chip before firing and the electrically conductive paste applied to the multilayer chip before firing are simultaneously fired (calcined) to form a multilayer body in which the fired layer is formed. The temperature of the firing treatment at this time (firing temperature) is preferably, for example, about 900° C. or more and about 1400° C. or less.

Next, the plated layer 34 is formed. The plated layer 34 may be formed on the surface of the base electrode layer 32 or may be formed directly on the multilayer body 12. In addition, in the Experimental Examples described later, the plated layer 34 is formed on the surface of the base electrode layer 32. More specifically, for example, a Ni plated layer is formed as a lower plated layer on the base electrode layer 32, and a Sn plated layer is formed as an upper plated layer. It is possible to sequentially form the Ni plated layer and the Sn plated layer by barrel plating, for example. When plating is performed, either electrolytic plating or electroless plating may be used. However, electroless plating requires pretreatment with a catalyst or the like in order to improve the plating deposition rate, and has a disadvantage in that the process becomes complicated. Therefore, in general, it is preferable to use electrolytic plating.

As described above, the three-terminal multilayer ceramic capacitor 10 according to the present embodiment is manufactured.

Hereinafter, the advantageous effects of the three-terminal multilayer ceramic capacitor 10 will be described.

(1) Advantageous Effects of Thickness Relationship of Thicknesses tb₁ and tb₂ of the Third and Fourth Extension Electrode Portions 28b₁ and 28b₂>Thicknesses Ta₁ and Ta₂ of the First and Second Extension Electrode Portions 28a₁ and 28a₂≥Thickness of at Least One of Thicknesses t1 or t2 of the First or Second Counter Electrode Portions 26a and 26b

The inventors of example embodiments of the present invention have discovered that, in the relationships among the thicknesses ta₁ and ta₂ of the first and second extension electrode portions 28a₁ and 28a₂, the thicknesses tb₁ and tb₂ of the third and fourth extension electrode portions 28b₁ and 28b₂, and the thicknesses t1 and t2 of the first and second counter electrode portions 26a and 26b, an adverse effect such as a decrease in moisture resistance reliability, an increase in the dimension of the three-terminal multilayer ceramic capacitor 10, and configuration defects is caused in the relation of the thicknesses tb₁ and tb₂ of the third and fourth extension electrode portions 28b₁ and 28b₂<the thicknesses ta₁ and ta of the first and second extension electrode portions 28a₁ and 28a₂≤the thicknesses t1 or t2 of the first or second counter electrode portion 26a or 26b.

Based on this discovery, it has been discovered that the thickness relationship is set such that the thicknesses tb₁ and tb₂ of the third and fourth extension electrode portions 28b₁ and 28b₂>the thicknesses ta₁ and ta₂ of the first and second extension electrode portions 28a₁ and 28a₂> at least one of the thickness t1 or t2 of the first or second counter electrode portions 26a and 26b. As described above, it has been discovered that it is possible to reduce or prevent a decrease in moisture resistance reliability, an increase in dimensions of the three-terminal multilayer ceramic capacitor 10, configuration defects, and the like by forming the internal electrode layers 16 by defining the magnitude relationship in consideration of all of the thicknesses tb and tb₂ of the third and fourth extension electrode portions 28b₁ and 28b₂, the thicknesses ta₁ and ta₂ of the first and second extension electrode portions 28a₁ and 28a₂, and at least one of the thickness t1 or t2 of the first or second counter electrode portions 26a or 26b. The details will be described below.

According to the above-described configuration, the thicknesses tb₁ and tb₂ of the third and fourth extension electrode portions 28b₁ and 28b₂ are larger than at least one of the thickness t1 or t2 of the first or second counter electrode portion 26a or 26b. That is, the third and fourth extension electrode portions 28b₁ and 28b₂ are exposed on the first lateral surface 12c and the second lateral surface 12d at a thickness larger than at least one of the thickness t1 or t2 of the first or second counter electrode portion 26a or 26b. Therefore, it is possible to improve the adhesiveness between the third and fourth extension electrode portions 28b₁ and 28b₂ and the third and fourth external electrodes 30c and 30d. Specifically, for example, Ni in the third and fourth extension electrode portions 28b₁ and 28b₂ and Cu in the third and fourth external electrodes 30c and 30d are mutually diffused to form an alloy layer. This alloy layer is denser than the internal electrode layers 16 and the external electrode 30 itself, and improves the connectivity between the internal electrode layers 16 and the external electrode 30. Since the thicknesses tb₁ and tb₂ of the third and fourth extension electrode portions 28b₁ and 28b₂ are large as described above, the contact areas between the third and fourth extension electrode portions 28b₁ and 28b₂ and the third and fourth external electrodes 30c and 30d increase, and an alloy layer is provided in a larger range. Therefore, it is possible to improve the adhesiveness between the third and fourth extension electrode portions 28b₁ and 28b₂ and the third and fourth external electrodes 30c and 30d, to reduce or prevent moisture from infiltrating into the multilayer body 12 from between the third and fourth extension electrode portions 28b₁ and 28b₂ and the third and fourth external electrodes 30c and 30d, and to improve the moisture resistance reliability.

In addition, the thicknesses ta₁ and ta₂ of the first and second extension electrode portions 28a₁ and 28a₂ are larger than at least one of the thickness t1 or t2 of the first or second counter electrode portion 26a or 26b. That is, the first and second extension electrode portions 28a₁ and 28a₂ are exposed on the first end surface 12e and the second end surface 12f at a thickness larger than at least one of the thickness t1 or t2 of the first or second counter electrode portion 26a or 26b. Therefore, since the contact area between the first and second extension electrode portions 28a₁ and 28a₂ and the first and second external electrodes 30a and 30b is large and the alloy layer is large, it is possible to improve the adhesiveness between the first and second extension electrode portions 28a₁ and 28a₂ and the first and second external electrodes 30a and 30b, and to improve the moisture resistance reliability.

In addition, the thickness of at least one of the thickness t1 or t2 of the first or second counter electrode portion 26a or 26b is smaller than the thicknesses tb₁ and tb₂ of the third and fourth extension electrode portions 28b₁ and 28b₂, and the thickness of at least one of the thickness t1 or t2 of the first or second counter electrode portion 26a or 26b is equal to or smaller than the thicknesses ta₁ and ta₂ of the first and second extension electrode portions 28a₁ and 28a₂. Therefore, it is possible to reduce or prevent an increase in the thickness of the effective layer in which the first counter electrode portion 26a and the second counter electrode portion 26b are opposed to each other in the height direction x with the ceramic layers 14 interposed therebetween. Therefore, it is possible to reduce or prevent an increase in the dimension of the three-terminal multilayer ceramic capacitor 10 in the height direction x.

In addition, the thicknesses tb₁ and tb₂ of the third and fourth extension electrode portions 28b₁ and 28b₂ are larger than the thicknesses ta₁ and ta₂ of the first and second extension electrode portions 28a₁ and 28a₂. In other words, the thicknesses ta₁ and ta₂ of the first and second extension electrode portions 28a₁ and 28a₂ are smaller than the thicknesses tb₁ and tb₂ of the third and fourth extension electrode portions 28b₁ and 28b₂. Here, it is difficult to make the dimension in the height direction x of the three-terminal multilayer ceramic capacitor 10 constant in the length direction z, that is, distortion may occur in the length direction z. For example, when the multilayer body 12 in which the first internal electrode layers 16a, the second internal electrode layers 16b, and the ceramic layers 14 are laminated is cut while being conveyed in the length direction z, a cutting deviation may occur in the length direction z, and distortion may occur in the length direction z. In addition, the first internal electrode layers 16a and the second internal electrode layers 16b cannot be accurately overlapped with each other, and a lamination deviation may occur in the length direction z. In particular, when the lamination is performed while being conveyed in the length direction z, the lamination deviation in the length direction z may become large. In addition, in the first internal electrode layers 16a, printing deviation may occur in the length direction z. In particular, when printing is performed while being conveyed in the length direction z, printing deviation in the length direction z may become large. As described above, when the cut deviation, the lamination deviation, the printing deviation, and the like of the multilayer body 12 occur in the length direction z, it may not be possible to position the large portions of the thicknesses ta₁ and ta₂ of the first and second extension electrode portions 28a₁ and 28a₂ on the first and second end surfaces 12e and 12f, and it may not be possible to ensure a large exposure area of the first internal electrode layers 16a with respect to the external electrode. By increasing the length in the length direction z of the portions of the thicknesses ta₁ and ta₂ of the first and second extension electrode portions 28a₁ and 28a₂ in order to cope with this, it is possible to locate the large portions of the thicknesses ta₁ and ta₂ of the first and second extension electrode portions 28a₁ and 28a₂ on the first and second end surfaces 12e and 12f even when a cutting deviation, a lamination deviation, a printing deviation, or the like occurs. However, in this case, since the portions of the thicknesses ta₁ and ta₂ of the first and second extension electrode portions 28a₁ and 28a₂ are large in the length direction z, they may be laminated so as to overlap the second counter electrode portion 26b. Then, at least a portion where the portions of the thicknesses ta₁ and ta₂ of the first and second extension electrode portions 28a₁ and 28a₂ overlap with the thickness of the second counter electrode portion 26b becomes thick. It is considered that such lamination causes disadvantages such as a configuration defect and an increase in the dimension of the three-terminal 1 multilayer ceramic capacitor 10 in the height direction x. Therefore, by making the thicknesses ta₁ and ta₂ of the first and second extension electrode portions 28a₁ and 28a: smaller than the thicknesses tb₁ and the of the third and fourth extension electrode portions 28b₁ and 28b₂ as described above, it is possible to reduce or prevent an increase in the dimension in the height direction x of the three-terminal multilayer ceramic capacitor 10, and it is also possible to reduce or prevent configuration defects and the like, even when the first and second extension electrode portions 28a₁ and 28a₂ overlap the second counter electrode portion 26b due to a cutting deviation, a lamination deviation, a printing deviation, or the like. Further, the third and fourth extension electrode portions 28b₁ and 28b₂ and the third and fourth external electrodes 30c and 30d have improved connectivity by making the thicknesses tb₁ and the of the third and fourth extension electrode portions 28b₁ and 28b₂, which are less affected by the cutting deviation, the lamination deviation, the printing deviation, and the like in the length direction z, larger than the thicknesses ta₁ and ta₂ of the first and second extension electrode portions 28a₁ and 28a₂.

(2) Advantageous Effects when the Thicknesses Ta₁ and Ta₂ of the First Extension Electrode Portion 28a₁ and the Second Extension Electrode Portion 28a: Are 1.0 Times or More and 1.3 Times or Less than the t1 of the First Counter Electrode Portion 26a

By setting the thicknesses ta₁ and ta₂ of the first and second extension electrode portions 28a₁ and 28a₂ as described above, it is possible to improve the adhesiveness between the first internal electrode layers 16a and the first and second external electrodes 30a and 30b, and to achieve a reduction in size. Here, when the thicknesses ta₁ and ta₂ of the first and second extension electrode portions 28a₁ and 28a₂ are less than 1.0 times the thickness t1 of the first counter electrode portion 26a, the contact area between the first internal electrode layers 16a and the first and second external electrodes 30a and 30b becomes small, and it is not possible to improve the adhesiveness. On the other hand, when the thicknesses ta₁ and ta of the first and second extension electrode portions 28a₁ and 28a₂ are set to be larger than 1.3 times the thickness t1 of the first counter electrode portion 26a, the thickness of the three-terminal multilayer ceramic capacitor 10 becomes large, and it is not possible to achieve a reduction in size.

(3) Advantageous Effects when the Third and Fourth Extension Electrode Portions 28b₁ and 28b₂ have Thicknesses tb₁ and tb₂ of about 1.3 Times or More and about 1.7 Times or Less than the t2 of the Second Counter Electrode Portion 26b

By setting the thicknesses tb₁ and tb₂ of the third and fourth extension electrode portions 28b₁ and 28b₂ as described above, it is possible to improve the adhesiveness between the second internal electrode layers 16b and the third and fourth external electrodes 30c and 30d, and to achieve a reduction in size. Here, when the thicknesses tb₁ and tb₂ of the third and fourth extension electrode portions 28b₁ and 28b₂ are less than about 1.3 times the thickness t2 of the second counter electrode portion 26b, the contact area between the second internal electrode layers 16b and the third and fourth external electrodes 30c and 30d becomes small, and it is not possible to improve the adhesiveness. On the other hand, when the thicknesses tb₁ and tb₂ of the third and fourth extension electrode portions 28b₁ and 28b₂ are set to be larger than about 1.7 times the thickness t2 of the second counter electrode portion 26b, the thickness of the three-terminal multilayer ceramic capacitor 10 becomes large, and it is not possible to achieve a reduction in size.

(4) Advantageous Effects when Second Ni Diffusion Distance>First Ni Diffusion Distance

Since the second Ni diffusion distance is greater than the first Ni diffusion distance, the alloy layer provided between the second internal electrode layers 16b and the third and fourth external electrodes 30c and 30d is larger than the alloy layer provided between the first internal electrode layers 16a and the first and second external electrodes 30a and 30b. Therefore, it is possible to further improve the adhesiveness between the second internal electrode layers 16b and the third and fourth external electrodes 30c and 30d, to further reduce or prevent moisture from infiltrating into the multilayer body 12 from between the second internal electrode layers 16b and the third and fourth external electrodes 30c and 30d, and to further improve the moisture resistance reliability.

Next, in order to confirm the advantageous effects of the above-described three-terminal multilayer ceramic capacitor according to example embodiments of the present invention, three-terminal multilayer ceramic capacitors were manufactured by the above-described manufacturing method as samples for experiments, and a moisture resistance reliability test and Ni diffusion distance measurement were performed.

First, three-terminal multilayer ceramic capacitors according to Examples 1 to 10 having the following specifications were produced in accordance with the method for manufacturing a multilayer ceramic capacitor described above. In Examples 1 to 10, configurations other than the thickness (ta₁, ta₂) of the first extension electrode portion and the second extension electrode portion in the height direction x, the thickness (t1) of the first counter electrode portion in the height direction x, the thickness (tb₁, tb₂) of the third extension electrode portion and the fourth extension electrode portion in the height direction x, and the dimension (t2) of the second counter electrode portion in the height direction x were common. In addition, Examples 1 to 10 were 10 out of 72 samples manufactured in the same lot.

In Examples 1 to 10, the values of the thicknesses (ta₁, ta₂) of the first extension electrode portion and the second extension electrode portion in the height direction x, the thickness (t1) of the first counter electrode portion in the height direction x, the thicknesses (tb₁, tb₂) of the third extension electrode portion and the fourth extension electrode portion in the height direction x, and the dimension (t2) of the second counter electrode portion in the height direction x are different in each of Examples 1 to 10. Other design values are common in Examples 1 to 10.
⊚ Configuration of three-terminal multilayer ceramic capacitor: three terminals (see FIG. 1)
⊚ Dimensions L×W×T (including design values) of three-terminal multilayer ceramic capacitor: about 1.23 mm×about 0.93 mm×about 0.48 mm
⊚ Material of ceramic layer: BaTiO₃
⊚ Capacitance: about 22 μF
⊚ Rated voltage: about 4 V
⊚ First Internal Electrode Layers
   Material: Ni
   Shape: see FIGS. 4, 6, and 8
   Number of layers: 220 layers
   Thickness (ta₁, ta₂) of the first extension electrode portion and the second extension electrode portion in the height direction x: see Table 1
   Thickness (t1) of the first counter electrode portion in the height direction x: see Table 1
⊚ Second Internal Electrode Layers
   Material: Ni
   Shape: see FIGS. 5, 7, and 9
   Number of layers: 220 layers
   Thickness (tb₁, tb₂) of the third extension electrode portion and the fourth extension electrode portion in the height direction x: see Table 1
   Dimension (t2) of the second counter electrode portion in the height direction x: see Table 1
⊚ Configuration of External Electrode
   First external electrode and second external electrode
   Base electrode layer: fired layer including electrically conductive metal (Cu) and glass component
Thickness of middle portion of end surface: about 16 μm
   Plated layer: two-layer configuration of Ni plated layer and Sn plated layer
   Thickness of Ni plated layer: about 5 μm
   Thickness of Sn plated layer: about 5 μm
   Third external electrode and fourth external electrode
      Base electrode layer: fired layer including electrically conductive metal (Cu) and glass component
   Thickness of middle portion of lateral surface: about 12 μm
      Plated layer: two-layer configuration of Ni plated layer and Sn plated layer
      Thickness of Ni plated layer: about 4 μm
      Thickness of Sn plated layer: about 5 μm

Subsequently, a three-terminal multilayer ceramic capacitor according to Comparative Example 1 was produced, in which the configurations of the first internal electrode layers and the second internal electrode layers were different from those of Examples 1 to 10.

A three-terminal multilayer ceramic capacitor according to Comparative Example 1 was produced with the following design. Other configurations of Comparative Example 1 are the same or substantially the same as those of Examples 1 to 10.
⊚ First Internal Electrode Layers
   Thickness (ta₁, ta₂) of the first extension electrode portion and the second extension electrode portion in the height direction x: see Table 1
   Thickness (t1) of the first counter electrode portion in the height direction x: see Table 1
⊚ Second Internal Electrode Layers
   Thickness (tb₁, tb₂) of the third extension electrode portion and the fourth extension electrode portion in the height direction x: see Table 1
   Thickness (t2) of the second counter electrode portion in the height direction x: see Table 1

A moisture resistance reliability test and Ni diffusion distance measurement were performed on 72 samples manufactured in the same lot including Examples 1 to 10 and 72 samples of Comparative Example 1. In Examples 1 to 10, among the 72 samples manufactured in the same lot, a sample having a maximum thickness (ta₁, ta₂) and a sample having a minimum thickness (ta₁, ta₂) in the height direction x of the first extension electrode portion and the second extension electrode portion, a sample having a maximum thickness (t1) and a sample having a minimum thickness (t1) in the height direction x of the first counter electrode portion, a sample having a maximum thickness (tb₁, tb₂) and a sample having a minimum thickness (tb₁, tb₂) in the height direction x of the third extension electrode portion and the fourth extension electrode portion, and a sample having a maximum dimension (t2) and a sample having a minimum dimension (t2) in the height direction x of the second counter electrode portion were included.

Each sample was subjected to a moisture resistance reliability test based on a PCBT test method. More specifically, first, each sample was mounted on a mounting board using solder. Subsequently, the insulation resistance value IR of each sample was measured (the insulation resistance value after one hour from the start of the moisture resistance reliability test time). Next, the mounting board was placed in a high-temperature and high-humidity bath, and a DC current of about 4 V was applied between the first external electrode and the second external electrode of each sample and between the third external electrode and the fourth external electrode of each sample in an environment of about 125° C. and a relative humidity of about 95% RH, and maintained for about 72 hours (humidity resistance reliability test time). After the moisture resistance reliability test time, the insulation resistance value IR of each sample was measured (the insulation resistance value after the moisture resistance reliability test time). For each sample, when the log IR after the moisture resistance reliability test time was lower than the log IR before the moisture resistance reliability test time by the power of about 0.5 or more, it was determined that the sample was deteriorated by IR and counted.

The Ni diffusion distance of Ni of the internal electrode layers to the external electrode at the junction between the first to fourth external electrodes and the internal electrode layers was determined using the following apparatus for each of the cases where the firing temperature was set to about 680° C., about 700° C., about 720° C., and about 740° C., respectively. A region having a Ni content of about 10% or more with respect to the total of the Ni content and the Cu content (Ni content/(Ni content+Cu content)) from the interface between the external electrode and the internal electrode layers was defined as a Ni diffusion region. Within 256×256 pixels, for each of the 72 samples including Examples 1 to 10 and each of the 72 pieces of Comparative Example 1, the 30^{th} value among those having a large Ni diffusion distance from the interface was acquired as the Ni diffusion distance of each sample. In addition, as experimental results, an average value of Ni diffusion distances of the 72 samples including Examples 1 to 10 and an average value of Ni diffusion distances of the 72 samples of Comparative Example 1 were obtained at the firing temperatures of about 680° C., about 700° C., about 720° C., and about 740° C., respectively.
FE-WDX (apparatus name: JEOL JXA-8500F)
Acceleration voltage: about 15.0 kV
Irradiation current: about 5×10⁻⁸ A
Field of view: about 25 μm×about 25 μm
Number of pixels: 256×256
Pixel size: about 0.0978 (4000 magnification)
Dwell Time (time taken by one pixel): about 40 ms
Scanning Method: beam
Depth of Analysis: about 1 μm to about 2 μm
Measurable Elements: Ni, Cu

Table 1 shows design values of the samples of Examples 1 to 10 and Comparative Example 1.

TABLE 1

| | Thickness of the middle | Thickness of the first | Thickness of the third | | |
|---|---|---|---|---|---|
| | portion of the first and | and second extraction | and fourth extraction | | |
| | second counter electrode | electrode portions in | electrode portions in | | |
| | portions in the WT cross | the LT cross section | the WT cross section | | |
| | section at the position of | at the position of | at the position of | | |
| | 1/2L | 1/2 W | 1/2L | | |
| Sample | t1, t2 (t1 ≈ t2) | ta1, ta2 (ta1 ≈ ta2) | tb1, tb2 (tb1 ≈ tb2) | ta1(ta2)/ | tb1(tb2)/ |
| Number | (um) | (um) | (um) | t1(t2) | t1(t2) |
| Example 1 | 0.41 | 0.51 | 0.64 | 1.24 | 1.56 |
| Example 2 | 0.30 | 0.40 | 0.47 | 1.33 | 1.57 |
| Example 3 | 0.41 | 0.55 | 0.56 | 1.34 | 1.37 |
| Example 4 | 0.37 | 0.47 | 0.53 | 1.27 | 1.43 |
| Example 5 | 0.38 | 0.46 | 0.56 | 1.21 | 1.47 |
| Example 6 | 0.41 | 0.45 | 0.56 | 1.10 | 1.37 |
| Example 7 | 0.35 | 0.45 | 0.49 | 1.29 | 1.40 |
| Example 8 | 0.39 | 0.46 | 0.50 | 1.18 | 1.28 |
| Example 9 | 0.35 | 0.35 | 0.49 | 1.00 | 1.40 |
| Example 10 | 0.45 | 0.58 | 0.77 | 1.29 | 1.71 |
| Comparative | 0.48 | 0.47 | 0.50 | 0.98 | 1.04 |
| Example 1 | | | | | |

Table 2 shows experimental results of the moisture resistance reliability test.

TABLE 2

| | Insulation resistance |
|---|---|
| | (IR) degradation count |
| Examples 1-10 | 0/72 |
| Comparative Example 1 | 3/72 |

Table 3 shows experimental results of Ni diffusion distance.

TABLE 3

| | | Firing Temperature (° C.) | | | |
|---|---|---|---|---|---|
| | | 680 | 700 | 720 | 740 |
| Examples | Second Ni diffusion distance | 1.70 | 1.96 | 2.45 | 2.93 |
| 1-10 | (um) from third and fourth | | | | |
| | extraction electrode portions | | | | |
| | First Ni diffusion distance | 1.63 | 1.93 | 1.69 | 2.12 |
| | (um) from first and second | | | | |
| | extraction electrode portions | | | | |
| | Second Ni diffusion distance/ | 1.04 | 1.02 | 1.45 | 1.38 |
| | first Ni diffusion distance | | | | |
| Comparative | Second Ni diffusion distance | 1.68 | 1.73 | 1.90 | 2.34 |
| Example | (um) from third and fourth | | | | |
| | extraction electrode portions | | | | |
| | First Ni diffusion distance | 1.59 | 1.68 | 1.76 | 2.20 |
| | (um) from first and second | | | | |
| | extraction electrode portions | | | | |
| | Second Ni diffusion distance/ | 1.06 | 1.03 | 1.08 | 1.06 |
| | first Ni diffusion distance | | | | |

As shown in the results of Table 2, for the 72 samples including Examples 1 to 10, the number of samples in which IR degradation occurred was 0. On the other hand, in Comparative Example 1, there were three samples in which IR degradation occurred, and it was discovered that the moisture resistance reliability had declined. Therefore, it was discovered that the samples of Examples 1 to 10 did not suffer from IR degradation, and a decrease in moisture resistance reliability was reduced or prevented, and moisture resistance reliability was ensured.

In Examples 1 to 10 in which the moisture resistance reliability was ensured, the thickness relationship was such that the thickness in the height direction x of the third and fourth extension electrode portions>the thickness in the height direction x of the first and second extension electrode portions>the thickness in the height direction x of the first and second counter electrode portions. On the other hand, in Comparative Example 1 in which the moisture resistance reliability had declined, the thickness relationship was such that the thickness in the height direction x of the third and fourth extension electrode portions>the thickness in the height direction x of the first and second counter electrode portions>the thickness in the height direction x of the first and second extension electrode portions.

Therefore, it was discovered that it was possible to ensure the moisture resistance reliability of the three-terminal multilayer ceramic capacitor with the thickness relationship derived from Examples 1 to 10. From the calculation results related to Examples 1 to 10 in Table 1, it was discovered that the thicknesses ta₁ and ta₂ of the first and second extension electrode portions in the height direction x were preferably about 1.0 times or more and about 1.3 times or less than the t1 of the first counter electrode portion in the height direction x (or the thickness t2 of the second counter electrode portion in the height direction x). In other words, in Examples 1 to 10, the minimum value of ta₁ (ta₂)/t1 (t2) was about 1.00 in Example 9 and the maximum value was about 1.34 in Example 3, and when rounded off, the minimum value was about 1.0 and the maximum value was about 1.3.

In addition, from the calculation results related to Examples 1 to 10 in Table 1, it was found that the thicknesses tb₁ and tb₂ of the third and fourth extension electrode portions in the height direction x were preferably about 1.3 times or more and about 1.7 times or less than the t1 of the second counter electrode portion in the height direction x (or the thickness t2 of the second counter electrode portion in the height direction x). In other words, in Examples 1 to 10, the minimum value of tb1(tb2)/t1(t2) was about 1.28 in Example 8, the maximum value was about 1.71 in Example 10, and when rounded off, the minimum value was about 1.3 and the maximum value was about 1.7.

In addition, from the calculation results related to Examples 1 to 10 in Table 3, it was found that the ratio of the second Ni diffusion distance to the first Ni diffusion distance was preferably about 1.04 or more and about 1.45 or less. More preferably, it was about 1.05 or more and about 1.40 or less.

In addition, as described above, example embodiments of the present invention are disclosed in the above description, but the present invention is not limited thereto. That is, it is possible to make various modifications to the example embodiments described above without departing from the technical idea and the scope of the present invention with respect to the configurations, the shapes, the materials, the quantities, the positions, the arrangements, and the like, and these modifications are included in the present invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A three-terminal multilayer ceramic capacitor comprising:
a multilayer body including a plurality of ceramic layers that are laminated, a first main surface and a second main surface opposed to each other in a height direction, a first end surface and a second end surface opposed to each other in a length direction orthogonal or substantially orthogonal to the height direction, and a first lateral surface and a second lateral surface opposed to each other in a width direction orthogonal or substantially orthogonal to the height direction and the length direction;
a plurality of first internal electrode layers each on a corresponding one of the plurality of ceramic layers and each extending toward the first end surface and the second end surface;
a plurality of second internal electrode layers each on a corresponding one of the plurality of ceramic layers and each extending toward the first lateral surface and the second lateral surface;
a first external electrode on the first end surface and connected to the plurality of first internal electrode layers;
a second external electrode on the second end surface and connected to the plurality of first internal electrode layers;
a third external electrode on the first lateral surface and connected to the plurality of second internal electrode layers; and
a fourth external electrode on the second lateral surface and connected to the plurality of second internal electrode layers; wherein
each of the plurality of first internal electrode layers includes a first counter electrode portion opposed to the plurality of second internal electrode layers, a first extension electrode portion extending from the first counter electrode portion toward the first end surface, and a second extension electrode portion extending from the first counter electrode portion toward the second end surface;
each of the plurality of second internal electrode layers includes a second counter electrode portion opposed to the plurality of first counter electrode portion, a third extension electrode portion extending from the second counter electrode portion toward the first lateral surface, and a fourth extension electrode portion extending from the second counter electrode portion toward the second lateral surface; and
a relationship is satisfied in which thicknesses of the third extension electrode portion and the fourth extension electrode portion in the height direction>thicknesses of the first extension electrode portion and the second extension electrode portion in the height direction≥at least one of a thickness of the first counter electrode portion or a thickness of the second counter electrode portion in the height direction.

2. The three-terminal multilayer ceramic capacitor according to claim 1, wherein the thicknesses of the first and second extension electrode portions in the height direction are each about 1.0 times or more and about 1.3 times or less than the thickness of the first counter electrode portion in the height direction.

3. The three-terminal multilayer ceramic capacitor according to claim 1, wherein the thicknesses of the third and fourth extension electrode portions in the height direction are each about 1.3 times or more and about 1.7 times or less than the of the second counter electrode portion in the height direction.

4. The three-terminal multilayer ceramic capacitor according to claim 1, wherein
when a region in which a Ni content is about 10% or more with respect to a total of a Ni content and a Cu content is defined as a diffusion region of Ni;
a second Ni diffusion distance in the width direction of Ni from the third extension electrode portion and the fourth extension electrode portion to the third external electrode and the fourth external electrode with reference to the first lateral surface and the second lateral surface of the multilayer body is about 1.05 times or more and about 1.4 times or less a first Ni diffusion distance in the length direction of Ni from the first extension electrode portion and the second extension electrode portion to the first external electrode and the second external electrode with reference to the first end surface and the second end surface of the multilayer body.

5. The three-terminal multilayer ceramic capacitor according to claim 1, wherein each of the plurality of ceramic layers includes BaTiO₃, CaTiO₃, SrTiO₃, or CaZrO₃ as a main component.

6. The three-terminal multilayer ceramic capacitor according to claim 5, wherein each of the plurality of ceramic layers includes a Mn compound, a Fe compound, a Cr compound, a Co compound, or a Ni compound as a subcomponent.

7. The three-terminal multilayer ceramic capacitor according to claim 1, wherein a thickness of each of the plurality of ceramic layers is about 0.3 μm or more and about 5.0 μm or less.

8. The three-terminal multilayer ceramic capacitor according to claim 1, wherein each of the plurality of first and second internal electrode layers includes Ni as a main component, and Cu, Ag, Pd, or Au, or an alloy including at least one of Cu, Ag, Pd, or Au.

9. The three-terminal multilayer ceramic capacitor according to claim 1, wherein a thickness of each of the plurality of first and second internal electrode layers is about 0.30 μm or more and about 1.0 μm or less.

10. The three-terminal multilayer ceramic capacitor according to claim 1, wherein each of the first, second, third, and fourth external electrodes includes a base electrode layer including a metal component and a glass component, and a plated layer on a surface of the base electrode layer.

11. The three-terminal multilayer ceramic capacitor according to claim 10, wherein the glass component includes at least one of B, Si, Ba, Mg, Al, or Li.

12. The three-terminal multilayer ceramic capacitor according to claim 10, wherein the metal component includes at least one of Ni, Ag, Pd, an Ag—Pd alloy, or Au.

13. The three-terminal multilayer ceramic capacitor according to claim 10, wherein a thickness of the base electrode layer is about 3 μm or more and about 20 μm or less.

14. The three-terminal multilayer ceramic capacitor according to claim 10, wherein the plated layer includes a lower plated layer and an upper plated layer on the lower plated layer.

15. The three-terminal multilayer ceramic capacitor according to claim 14, wherein the lower plated layer includes Ni and the upper plated layer includes Sn.

16. The three-terminal multilayer ceramic capacitor according to claim 14, wherein a thickness of each of the lower plated layer and the upper plated layer is about 2.0 μm or more and about 15.0 μm or less.

17. The three-terminal multilayer ceramic capacitor according to claim 1, wherein
a dimension of the three-terminal multilayer ceramic capacitor in the length direction is about 1.05 mm or more and about 1.35 mm or less;
a dimension of the three-terminal multilayer ceramic capacitor in the height direction is about 0.45 mm or more and about 0.90 mm or less; and
a dimension of the three-terminal multilayer ceramic capacitor in the width direction is about 0.60 mm or more and about 0.95 mm or less.
